(19) United States
(12) Patent Application Publication
(10) Pub. No.: US 2025/0053833 A1
(43) Pub. Date: Feb. 13, 2025

(54) HOLISTIC LOGICAL INFERENCE MODEL FOR UNSTRUCTURED DATA ANALYSIS

(71) Applicant: Innovative Solutions Professionals, LLC, Leawood, KS (US)

(72) Inventors: Christopher Paul Waner, Kansas City, MO (US); James Lee Morgan, Overland Park, KS (US)

(21) Appl. No.: 18/366,853

(22) Filed: Aug. 8, 2023

(51) Int. Cl. G06N 5/04

(52) U.S. Cl. CPC G06N 5/04

(57) ABSTRACT

Disclosed herein are systems, methods, and computer-readable media for a holistic logical inference model. Unstructured data, which can include text, is received at an automated reasoning via natural intelligence (ARNI) system. A logical inference model is applied to at least one or more portions of the unstructured data. Meaning is generated from the at least one or more portions of the unstructured data based on an induction heuristic model.

### BACKGROUND

Machine learning (ML) for natural language processing (NLP) and text analytics involves using machine learning algorithms and/or artificial intelligence (AI) models to understand the meaning of text documents. These documents can be just about anything that contains text: medical reports, social media comments, online reviews, survey responses, and even financial, medical, legal, and/or regulatory documents. In essence, the role of machine learning and AI in NLP and text analytics is to accelerate and automate the underlying text analytics functions and NLP features that turn unstructured text into useable data and insights.

However, human language is incredibly complex, fluid, and inconsistent and presents serious challenges that ML algorithms and AI models are unable to overcome. ML algorithms and AI models lack contextual awareness, such as contextual words, phrases, and homonyms. In human language, the same words and phrases can have different meanings according to the context of a sentence, and many words—especially in English—have the exact same pronunciation but totally different meanings. Synonyms can lead to issues similar to contextual understanding because many different words can be used to express the same idea. Furthermore, some of these words may convey exactly the same meaning, while some words may have nuanced levels of complexity (e.g., small, little, tiny, minute), and different people use synonyms to denote slightly different meanings within their personal vocabulary. ML algorithms and AI models also struggle with ambiguity, where sentences and phrases can have two or more possible interpretations leading to lexical ambiguity, semantic ambiguity, syntactic ambiguity, etc. Other problems for ML algorithms and AI models are related to domain-specific language, irony and sarcasm, colloquialisms and slang (both in casual and professional settings), and errors in speech and text.

What is needed is a technique for analyzing unstructured text that generates meaning by mimicking a human-based logical reasoning framework-one in which contextual analysis and phrase recognition transcends the limitations of ML algorithms and AI models to recognize and unlock the real complexities of human language.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example report with unstructured text in accordance with an example embodiment.

FIG. 2 illustrates an example flow diagram of an automated reasoning via natural intelligence (ARNI) system in accordance with an example embodiment.

FIG. 3 illustrates an example method for automated reasoning via natural intelligence in accordance with an example embodiment.

FIG. 4 illustrates report node creations within the ARNI system in accordance with an example embodiment.

FIG. 5 illustrates the creation of sentence nodes within the ARNI system in accordance with an example embodiment.

FIG. 6 illustrates tokenization within the ARNI system in accordance with an example embodiment.

FIG. 7 illustrates connecting archetypes to sentences within the ARNI system in accordance with an example embodiment.

FIG. 8 illustrates connecting archetypes through microgrammatical analysis within the ARNI system in accordance with an example embodiment.

FIG. 9 illustrates creating logics nodes within the ARNI system in accordance with an example embodiment.

FIG. 10 illustrates the creation of summary nodes based on the logics nodes within the ARNI system in accordance with an example embodiment.

FIG. 11 illustrates a transverse Tree of Operational Requirement (TOOR) to determine requirement satisfaction within the ARNI system in accordance with an example embodiment.

FIG. 12 illustrates code selection within the ARNI system in accordance with an example embodiment.

FIG. 13 illustrates an example of a computing system, according to some aspects of the present disclosure

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

The present disclosure is directed to techniques for automated reasoning via natural intelligence of unstructured data in order to generate meaning from unstructured data using a human-based logical reasoning framework.

In one aspect, a method for a holistic logical inference model includes receiving unstructured data, where the unstructured data includes text. A logical inference model is applied to at least one or more portions of the unstructured data. Meaning is generated from the at least one or more portions of the unstructured data based on an induction heuristic model.

In another aspect, contextual analysis and phrase recognition is applied to the at least one or more portions of the unstructured data. Based on the contextual analysis and phrase recognition, the logical inference model is applied that combines the induction heuristic model with at least one deductive technique to generate the meaning to the at least one or more portions of the unstructured data, where the logical inference model mimics human logical reasoning applied to the unstructured data.

In another aspect, a portion of the text within the unstructured data is assigned to a labelled section and the labelled section is attached to a report node within a knowledge graph. The portion of the text is broken into one or more sentences and the one or more sentences is attached to a section node within the knowledge graph. The one or more sentences are broken into one or more tokens and the one or more tokens are attached to a sentence node within the knowledge graph. The report node, the section node, and the sentence node preserves ordered position within the knowledge graph.

In another aspect, one or more tokens are determined from the text of the unstructured data. Compound tokens are recognized from among unitary tokens within the one or more tokens by cross referencing ontological static data in memory. A unitary token archetype association is applied to portions of the unstructured data for unitary tokens, and a compound archetype association is applied to the portions of the unstructured data for compound tokens.

In another aspect, a plurality of archetype associations are connected together based on a microgrammatical analysis of the text, where the microgrammatical analysis of the text is based on one or more of a phrase or sentence proximity. An ephemeral knowledge graph of the unstructured data is built based on the connection of the plurality of archetype associations.

In another aspect, one or more archetypes within the plurality of archetype associations are inferred by the logical inference model.

In another aspect, ontological logic nodes are created based on the unstructured data. An ephemeral logics graph is built based on the ontological logic nodes, and the logical inference model is applied to solve syllogisms applied to the text by setting inclusion or exclusion properties on archetypal relationships to the ontological logic nodes.

In another aspect, valid pathways through a static knowledge graph are determined based on a comparison between nodes of an ephemeral knowledge graph and summary graphs of a report. Requirement logics operations are performed on returned transversal pathways. A recursive check is run for an existence of a coded conclusion for the returned transversal pathways until a coded conclusion has been reached or no transversal pathway matches results of the logics operations. If the coded conclusion has been reached, a code is assigned to a portion of the text.

In one aspect, a computing apparatus includes a processor and a memory storing instructions that, when executed by the processor, configure the apparatus to receive unstructured data, where the unstructured data includes text. A logical inference model is applied to at least one or more portions of the unstructured data. Meaning is generated from the at least one or more portions of the unstructured data based on an induction heuristic model.

In one aspect, a non-transitory computer-readable storage medium includes instructions that when executed by a computer, cause the computer to receive unstructured data, where the unstructured data includes text. A logical inference model is applied to at least one or more portions of the unstructured data. Meaning is generated from the at least one or more portions of the unstructured data based on an induction heuristic model.

### Description of Example Embodiments

The analysis of human language within the mind to generate understanding and meaning is complex: such as whether human language is based on logic, whether logic is based on language, or whether both language and logic are based on imagery. The content of language can express concrete images, for example, that is directly related to specific actions. However, the syntax and function of the same content words can also express a large amount of complex logic: possibility, necessity, tenses, indexicals, conditionals, causality, quotations, metalanguage about the language itself, etc.

The reasoning abilities of even the most simplistic of language use, such as language spoken by children, have challenged the syntax-based theories of logic and linguistics on which ML and AI models have been built. For instance, the semantic aspects of imagery, action, and feelings appear to be more important than syntax in most instances. A distinctive feature of human brains, for example, is the ability to create neural maps. In addition to the creation of maps, brains are also creating images (the main currency of human minds). Ultimately, consciousness as expressed by language allows one to experience maps as images, to manipulate those images, and to apply reasoning to them.

The maps and images within a human mind form mental models of the real world or of imaginary worlds in each person's hopes, fears, plans, and desires are expressed. They provide a “model theoretic” semantics for language that uses perception and action for testing models against reality. They can define the criteria for truth, but they are also flexible, dynamic, and situated in the daily drama of life. It stands to reason that all human reasoning is based on a concrete, but possibly changing, mental image that may be aided by a model constructed by the mind. Determining meaning in any analytical framework must take into account these nuances and complexities of human expressions.

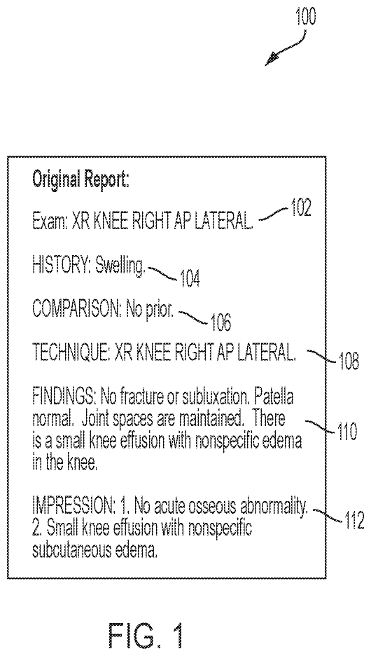

Take, for example, FIG. 1, which illustrates an example medical report 100 with unstructured text in accordance with an example embodiment. While an example medical report is shown in this particular example embodiment, any document (physical or digital) and/or data source with unstructured text is contemplated by alternative embodiments. These documents, for example, can be just about anything that contains text including, but not limited to: medical reports, social media comments, online reviews, survey responses, and even financial, medical, legal, and/or regulatory documents.

In FIG. 1, the medical report 100 contains unstructured text related to a type of medical examination 102—in this case, an “XR KNEE RIGHT AP LATERAL” type of medical examination. More information is noted by the examining professional-such as history 104 of the event causing the medical examination type (e.g., “Swelling”), comparison 106 to previous events (e.g., “No prior”), the technique 108 used by the examining professional (e.g., “XR KNEE RIGHT AP LATERAL”), the findings 110 (e.g., “No fracture or subluxation. Patella normal. Joint spaces are maintained. There is a small knee effusion with nonspecific edema in the knee”), and other impressions 112 (e.g., “1. No acute osseous abnormality. 2. Small knee effusion with nonspecific subcutaneous edema”).

In order to understand the content of the medical report 100, the analytical framework must go beyond the abilities of machine learning and AI in NLP, which is limited to specific word choice that form patterns within large datasets, and which completely misses the complexities needed to fully understand the nuanced meaning within the medical report 100 that's not directly expressed, indirectly expressed, and/or expressed in a unique manner to the examining professional. One or more models that are analogous to visualization for discovering a proof or logical conclusion is needed, such as visualization techniques centered around graph notations that use visual methods in the proof itself. For example, relational graphs and existential graphs (EGs) (using nested ovals to represent scope) can be methods by which diagrammatic logic can be implemented. The logic-based methods of induction, abduction, and deduction are based on the same kinds of analogies used in observation and imagination. These ideas in combination with existential graphs not only have a simpler mapping to and from language and imagery, they also have a direct mapping to simpler rules of inference with an elegant version of model theory with which to analyze language. Some applications of this idea can be ephemeral and/or static knowledge graphs, as will be discussed further herein.

An accurate analysis of the nuances of human understanding and interpretation of the language within the medical report 100 is needed. For the example embodiment shown, physicians are paid by applying the correct numeric code for the treatment provided. The process of transforming treatment detail into billable codes is known as Medical Coding. However, multiple problems arise within Medical Coding that need more nuanced text analysis than machine learning, AI, or NLP techniques. For example, the text within the medical report 100 may contain content that has subjective accuracy, meaning that any two experts may have differing opinions on the proper procedure codes. Moreover, assigning the proper procedure codes can be labor intensive, requiring continuous education and training. High human error rates are common, based on one or more of subjective accuracy, mis-coding, and/or typos. While Computer Assisted Coding (CaC) attempts to map medical text to a list of possible codes, CaC fails for the more nuanced cases requiring subjective accuracy and/or cases of mis-coding or typos. Offshore coding can be cost effective for non-complex medical procedures, but offshore systems suffer from higher error rates and data security concerns. These same types of issues span across all manner of text that must be analyzed accurately and quickly.

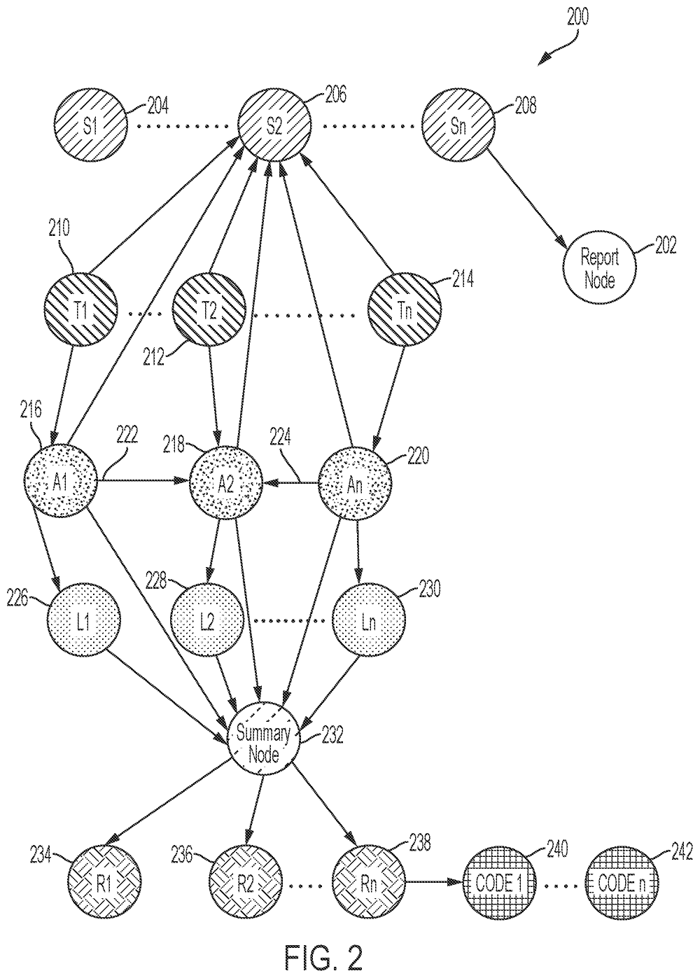

As a result, the systems and methods disclosed herein describe techniques the medical report 100 is analyzed using a holistic logical inference model. FIG. 2, for example, illustrates an example flow diagram of an automated reasoning via natural intelligence (ARNI) system 200 in accordance with one or more example embodiments.

The ARNI system 200 analyzes unstructured data using a holistic logical inference model. According to some example embodiments, the ARNI system can receive unstructured data, which may include text, and then apply a logical inference model to at least one or more portions of the unstructured data, such as a logical inference model that applies an induction heuristic model to the one or more portions of the unstructured data to generate a meaning to the at least one or more portions of the unstructured data. For instance, the ARNI system 200 can be a modal graph-based domain specific language processor, which can combine induction heuristics with deductive techniques to deduce the content and meaning of language.

For example, in the example embodiment shown, a portion or all of the text within the unstructured data, such as text in medical report 100 of FIG. 1, can be assigned to a labelled section, such as sections 102-112 of the medical report 100. One labelled section, a portion of the labelled sections, and/or all of the labelled sections can be attached to a Report Node 202 within a knowledge graph 200. The knowledge graph 200 can create sentence nodes based on the labelled sections within the Report Node 202. For example, each labelled section can be broken into one or more sentences and attached to sentence node S1 204, sentence node S2 206, . . . sentence node Sn 208 within the knowledge graph 200.

Each sentence can then be further broken down into one or more tokens in a tokenization process, such as breaking sentence node S2 206 into token node T1 210, token node T2 212, . . . token node Tn 214. For example, tokens may be words and/or punctuation which have an ordered position within each sentence node. Tokens can include, for example, the part of speech it belongs to, its plural state, characterization of its type within language, whether it has static meaning within language, etc. In some embodiments, the Report Node 202, sentence nodes S1 204 . . . . Sn 208, and/or the token nodes T1 210 . . . . Tn 214 preserves ordered position within the knowledge graph 200. As will be disclosed further herein, the tokens determined by the knowledge graph 200 may include unitary tokens and/or compound tokens based on ontological static data in memory.

In the example embodiment shown, one or more archetypes are connected to sentences. For example, the one or more tokens (e.g., token nodes T1 210 . . . . Tn 214) and/or the sentences (e.g., sentence nodes S1 204 . . . . Sn 208) can be associated with one or more archetypes. The archetype can include, but is not limited to: a name, ontology, ontology type, descriptive characteristics (e.g., type of, part of, structural component of a body), systems the archetype belongs to, taxonomical region, affect, medical classification, etc. The archetype can be a typical example of a person or object; a recurrent symbol, theme, or motif within the medical report 100, and/or distinctive imagery or visualization in which a logical framework can be built. In some embodiments, one or more archetypes within the associations can be inferred by one or more logical inference models.

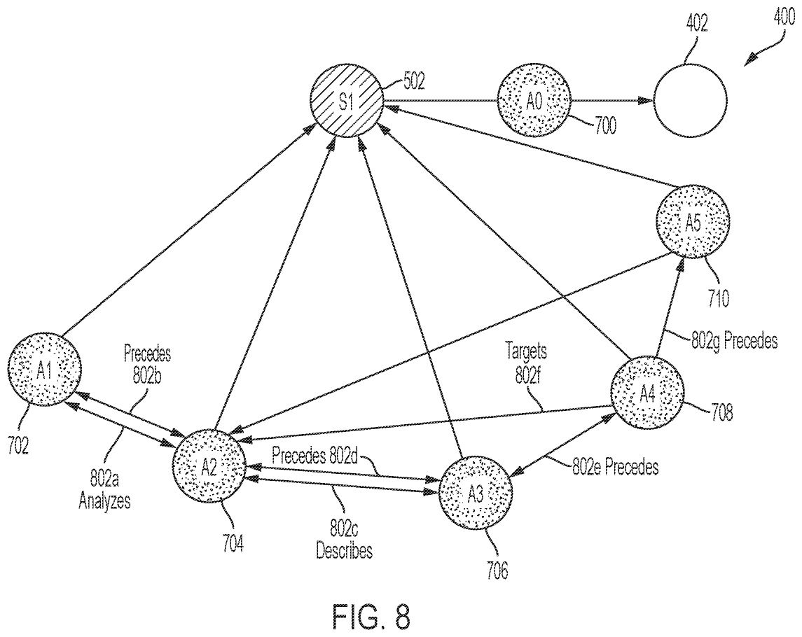

In knowledge graph 200, for instance, archetype node A1 216 is associated with token node T1 210 and sentence node S2 206; archetype node A2 218 is associated with token node T2 212 and sentence node S2 206; and archetype node An 220 is associated with token node Tn 214 and sentence node S2 206. In some embodiments, each archetype can be associated with another archetype, such as archetype node A1 being associated (222) with archetype node A2 218, and archetype node An 220 being associated (224) with archetype node A2 218. In some embodiments, microgrammars can be used to connect archetypes (discussed in more detail herein in FIG. 8).

In some embodiments, an ephemeral logics graph can be created based on connections between one or more ontological logic nodes, each logic node associated with at least one archetype node (although any number of archetype nodes can be associated with each logic node). For example, in knowledge graph 200, logic node L1 226 is associated with archetype node A1 216, logic node L2 228 is associated with archetype node A2 218, and logic node Ln 230 is associated with archetype node An 220. In some embodiments, one or more of the logical inference models can solve syllogisms applied to the text by setting inclusion or exclusion properties on archetypal relationships to the ontological logic nodes.

A summary node 232 can utilize the logics nodes (e.g., logic node L1 226, logic node L2 228, and/or logic node Ln 230) and/or the archetype nodes (e.g., archetype node A1 216, archetype node A2 218, and/or archetype node An 220) to generate a summary of all or a portion of the analyzed information from the unstructured text of medical report 100. In some embodiments, the summary node 232 can determine and/or analyze the dimensions of the information related to the unstructured text, and synthesize a new statement of fact. In some instances, the new statement of fact may be more specific in all or a portion of the variable dimensions than any single instance of the concept within the medical report 100.

In some embodiments, the knowledge graph 200 may determine if one or more requirement logics operations are satisfied within the summary node 232. For example, the knowledge graph 200 can determine whether pathways are valid based on whether the output from the summary node 232 satisfies the conditions specified by requirements node R1 234, requirements node R2 236, and requirements node Rn 238. Once all or a threshold number of requirements nodes are verified by the knowledge graph 200 to have valid pathways, one or more codes can be assigned to its respective portion of the text. For example, one portion of the text from the medical report 100 is assigned to code 1 240, and another portion of the text from the medical report 100 is assigned to code n 242. In some embodiments, a portion of the text can span one or more codes. These codes can then be output into any form by which medical coding is used within the medical healthcare system.

While the current embodiment has been discussed in relation to a medical document and medical coding, the knowledge graph 200 creation and utilization can be applied to any use for which text is analyzed. The knowledge graph 200 as described is a holistic logical inference technique which is designed to mimic human comprehension. Therefore, the knowledge graph 200 can be applied to just about anything that contains text: medical reports, social media comments, online reviews, survey responses, and even financial, medical, legal, and/or regulatory documents. The knowledge graph 200 can, using the methods and techniques described herein, turn that unstructured text into usable data and insights.

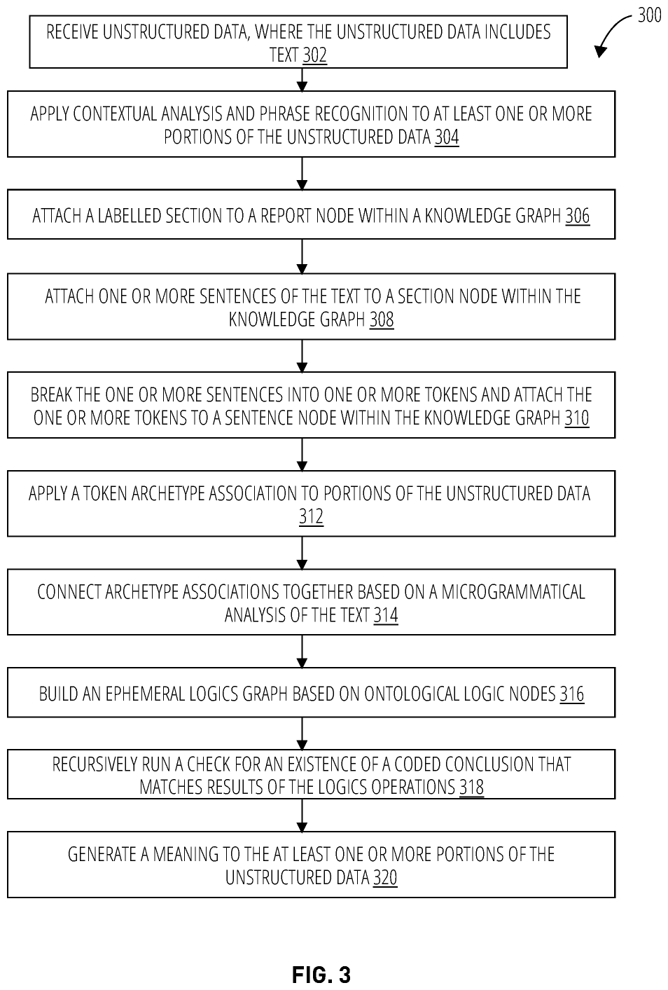

FIG. 3 illustrates an example routine 300 for automated reasoning via natural intelligence (ARNI) in accordance with an example embodiment. Although the example routine 300 depicts a particular sequence of operations, the sequence may be altered without departing from the scope of the present disclosure. For example, some of the operations depicted may be performed in parallel or in a different sequence that does not materially affect the function of routine 300. In other examples, different components of an example device or system that implements the routine 300 may perform functions at substantially the same time or in a specific sequence.

In block 302, routine 300 for a holistic logical inference model receives unstructured data. For example, the unstructured data can include text, images, and/or other representations of language. In block 304, routine 300 applies contextual analysis and phrase recognition to the at least one or more portions of the unstructured data. In some embodiments, based on the contextual analysis and the phrase recognition, one or more logical inference models are applied to the unstructured data that combines the induction heuristic model with at least one deductive technique to generate at least one meaning to the at least one or more portions of the unstructured data. The logical inference model can, for example, mimic human logical reasoning applied to the unstructured data through the use of ephemeral knowledge graphs such as the described in FIG. 1 and FIGS. 4-12.

Routine 300 can further assign a portion of text within the unstructured data to a labelled section and attach the labelled section to a report node within the knowledge graph in block 306. In block 308, the portion of the text is broken further into one or more sentences and the one or more sentences are then attached to at least one section node within the knowledge graph.

Tokenization can then occur for routine 300. The one or more sentences are broken into one or more tokens and the one or more tokens are attached to a sentence node within the knowledge graph in block 310. In some embodiments, the report node, the section node, and/or the sentence node preserves ordered position within the knowledge graph. In some embodiments, tokens can be unitary or compound. For example, compound tokens can be recognized from among unitary tokens by cross-referencing ontological static data in memory.

In block 312, an archetype can be associated with one or more tokens, based on determining that a portion of the unstructured data matches the archetype. Archetypes can be explicitly defined or can be inferred by logical inference model(s). In some embodiments, the archetype can span multiple types of token archetype characteristics, such as unitary or compound. For example, routine 300 can apply a unitary token archetype association to portions of the unstructured data for unitary tokens, and/or apply a compound archetype association to the portions of the unstructured data for compound tokens. In some embodiments, any number of archetype associations can be connected together based on a microgrammatical analysis of the text in block 314. For example, the microgrammatical analysis of the text can be based on one or more of a phrase or sentence proximity within the unstructured data. In some embodiments, an ephemeral knowledge graph of the unstructured data can be built based on the connection of these archetype associations.

Additionally and/or alternatively, in block 316 the ephemeral knowledge graph can be created and/or built from the creation of ontological logic nodes. For example, the logical inference model(s) can be applied to solve syllogisms applied to the text by setting inclusion or exclusion properties on archetypal relationships to the ontological logic nodes. Routine 300 can determine valid pathways through the knowledge graph based on a comparison between nodes of the ephemeral knowledge graph and summary graphs of a report. Requirement logics operations can be performed on returned transversal pathways, and a check can be recursively run for an existence of a coded conclusion for the returned transversal pathways in block 318. Routine 300 can run the recursive check until a coded conclusion has been reached or no transversal pathway matches results of the logics operations. Once a coded conclusion has been reached by the recursive check, a code can be assigned to a portion of the text. This code, or other means of generating meaning from the text, is a foundation for assigning meaning to at least one or more portions of the unstructured data in block 320.

In some embodiments, the ephemeral knowledge graph for which the ARNI system is based can be a modal graph-based domain specific language processor, which can combine induction heuristics with deductive techniques to deduce the content and meaning of language. These techniques can inform the creation of ontological logic nodes, the logical inference model(s) applied, and/or the requirement logics operations. For example, the ARNI system can implement modal logic, in which an expression (like “necessarily” or “possibly”) is used to qualify the truth of a judgement. Modal logic can be, for example, the study of the deductive behavior of the expressions “it is necessary that” and “it is possible that”. However, the term ‘modal logic’ may be used more broadly for a family of related systems. These include logics for belief, for tense and other temporal expressions, for the deontic (moral) expressions such as “it is obligatory that” and “it is permitted that”, and many others. An understanding of modal logic is particularly valuable in the formal analysis of expressions relating to philosophical argument, where expressions from the modal family are both common and confusing. Other logic systems that can be implemented within the ARNI system can include temporal logic (e.g., “it will always be the case that”, “it will be the case that”, “it has always been the case that”, “it was the case that”, etc.), doxastic logic (e.g., “xx believes that”, and/or epistemic logic (e.g., “xx knows that”, etc.), etc. The unstructured text or data can be analyzed based on the various logical expression types for their necessitation rules, distribution axioms, interaction axioms, etc. to determine symmetries/asymmetries between possible logical conclusions to be drawn from the text or data. The ARNI system may use one or a combination of multiple logical expression types, such as by determining correspondence between axioms and conditions between the multiple logical expression types.

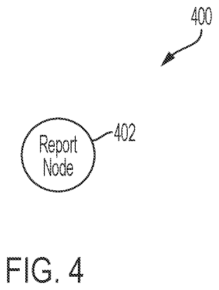

FIGS. 4-12 illustrate example embodiments from analyzing a document (e.g., medical report 100) in FIG. 1. While the following figures are discussed in relation to a medical document and medical coding, ephemeral knowledge graph creation and utilization can be applied to any use for which text is analyzed (e.g., anything that contains text, such as, but not limited to: medical reports, social media comments, online reviews, survey responses, and even financial, medical, legal, and/or regulatory documents). Using the methods and techniques described herein, any unstructured text can be turned into useable data and insights.

FIG. 4 illustrates report node creations within an automated reasoning via natural intelligence (ARNI) system 400 in accordance with an example embodiment. The ARNI system 400 mimics human comprehension through a holistic logical inference model. The ARNI system 400 can assign report text to the text property of a report node. In the shown example embodiment, the ARNI system 400 has taken in the medical report 100 of FIG. 1 with unstructured text. The portions of the text are assigned to one or more labelled sections, and the labelled sections 102-112 are attached to report node 402. For example, labelled sections 102-112 are associated with a tag of “report text” in report node 402, marking the medical report 100 as report text (rather than another type of text—e.g., social media comments, online reviews, survey responses, etc.). In some embodiments, report node 402 preserves the ordered position of the labelled sections 102-112 within the knowledge graph of the ARNI system 400.

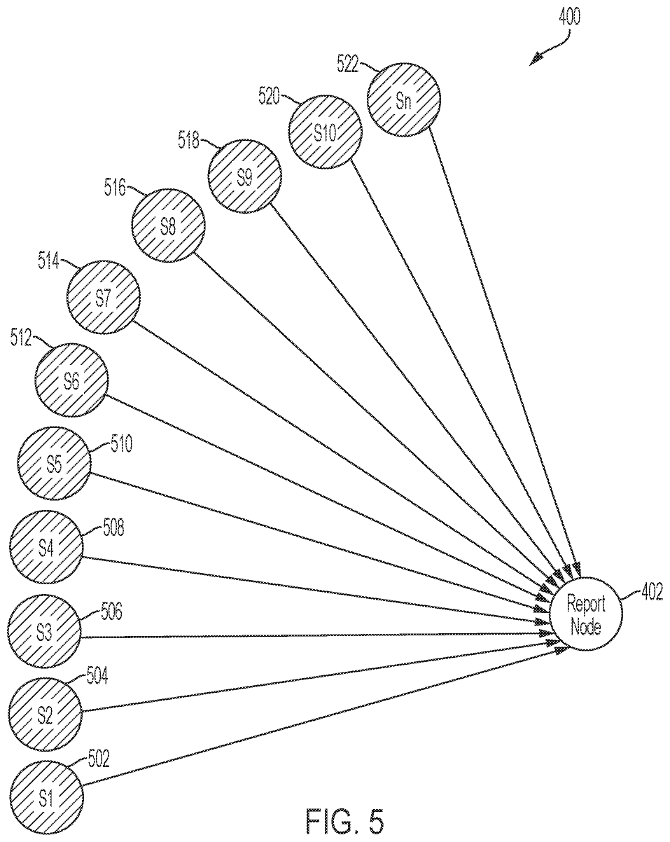

FIG. 5 illustrates the creation of sentence nodes within the ARNI system 400 in accordance with an example embodiment applied to the medical report 100. The ARNI system 400 can break portions of the text from the medical report 100 into one or more sentences and then attach the one or more sentences to a section node within an ephemeral knowledge graph.

For example, sentence node S1 502 isolates the text in labelled section 102 (e.g., “Exam: XR KNEE RIGHT AP LATERAL”), and determines what purpose the sentence is used for. In this case, sentence node S1 502 is created within the knowledge graph signifying the text section is “exam”, and can additionally and/or alternatively include the text in the labelled section 102 and/or its position (e.g., position: 1) in the medical report 100.

Similarly, sentence node S2 502 is created from another portion of text within the report node 402—labelled section 104—and determines that the sentence/text “swelling” is used for “indications”. Its position is assigned as (position: 2). Sentence node S3 506 is created from labelled section 106 and determines that the sentence/text “no prior” is used for “comparison”. Sentence node S4 508 is created from labelled section 108 and determines that the sentence/text “XR KNEE RIGHT AP LATERAL” is used for “technique”. Sentence node S5 510 is created from labelled section 110 and determines that the sentence/text “No fracture or subluxation” is used for “findings”.

Each labelled section can also be broken into its individual sentences. For example, sentence node S6 512 is created from labelled section 110 and determines that the sentence/text “Patella normal” is used for “findings”. Sentence node S7 514 is created from labelled section 110 and determines that the sentence/text “Joint spaces are maintained” is used for “findings”. Sentence node S8 516 is created from labelled section 110 and determines that the sentence/text “There is a small knee effusion with nonspecific edema in the knee” is used for “findings”. Similarly, sentence node S9 518 is created from labelled section 112 and determines that the sentence/text “1. No acute osseous abnormality” is used for “impressions”. Sentence node S10 520 is created from labelled section 112 and determines that the sentence/text “2. Small knee effusion with nonspecific subcutaneous edema” is used for “impressions”. Sentence node Sn 522 can be created from any other labelled section, if found, to determine what a sentence/text is used for.

In some embodiments, a portion or all of the sentence nodes preserve ordered position within the knowledge graph. For example, sentence node S1 502 has (position: 1) and sentence node S2 504 has (position: 2), and so on.

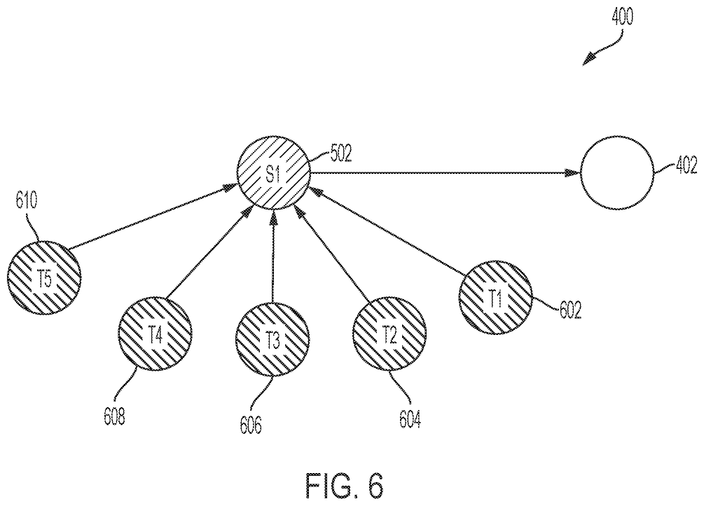

FIG. 6 illustrates tokenization within the ARNI system 400 in accordance with an example embodiment. Each sentence can be broken down into one or more tokens within the knowledge graph. For example, sentence node S1 502, which corresponds to “section: exam” with text “XR KNEE RIGHT AP LATERAL” in ordered position (position: 1) with the report text in report node 402, can be broken down into token node T1 602, token node T2 604, token node T3 606, token node T4 608, and token node T5 610.

For example, the ARNI system 400 can isolate “xr” within the text and create token node T5 610. Each token can be associated with a part of speech, its plurality state (singular vs plural), static meaning (true or false), token association name, and token type (unitary vs compound). In this example embodiment, token node T5 610 can be assigned as “xr” with part of speech: noun; plurality: singular; static: true; token: xr; and type: unitary. This token node, like all others within the ARNI system 400, can include flags or information that links the token node to its report node(s) (e.g., report node 402).

The rest of the text “XR KNEE RIGHT AP LATERAL” within sentence node S1 502 can be isolated and analyzed in the same way. Token node T4 608 can be assigned as “knee” with part of speech: noun; plurality: singular; static: true; token: knee; and type: unitary. Token node T3 606 can be assigned as “right” with part of speech: noun; plurality: singular; static: true; token: right; and type: unitary. Token node T2 604 can be assigned as “ap” with part of speech: noun; plurality: singular; static: true; token: ap; and type: unitary. Token node T1 602 can be assigned as “lateral” with part of speech: noun; plurality: singular; static: true; token: lateral; and type: unitary. And so on until the entire sentence within sentence node S1 502 has been assigned at least one token node.

In some embodiments, a portion or all of the token nodes preserve ordered position within the knowledge graph. For example, token node T5 610 has (position: 1) and token node T4 608 has (position: 2), and so on.

Additionally and/or alternatively, the token nodes can correspond to different types of tokens with varying characteristics. For example, token nodes can correspond to unitary and/or compound tokens. In some embodiments, compound tokens can be recognized from among unitary tokens within the one or more tokens by cross referencing ontological static data in memory (e.g., a preexisting graph engine with previously defined and/or created tokens).

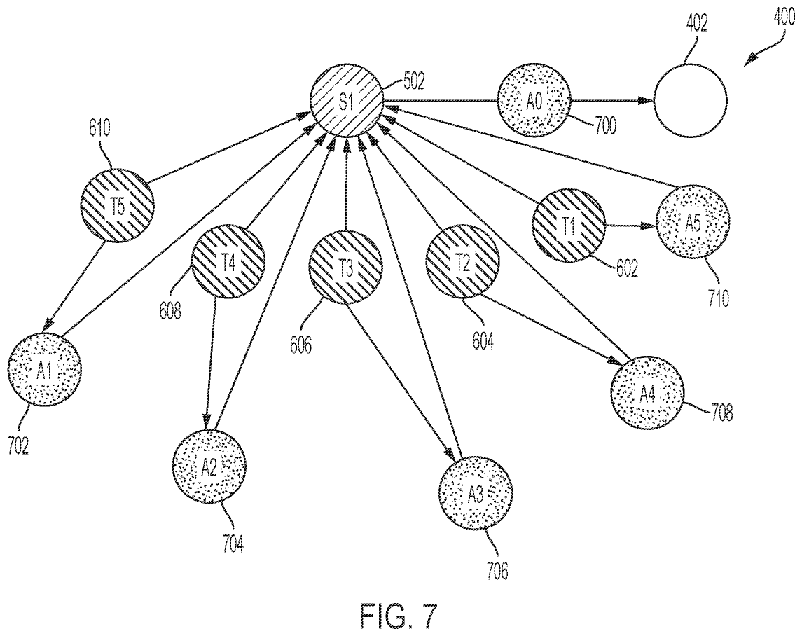

FIG. 7 illustrates connecting archetypes to sentences within the ARNI system in accordance with an example embodiment. One or more archetypes can be attached or associated with each token. The archetype can include, but is not limited to: a name, ontology, ontology type, descriptive characteristics (e.g., type of, part of, structural component of a body), systems the archetype belongs to, taxonomical region, affect, medical classification, etc. The archetype can be a typical example of a person or object; a recurrent symbol, theme, or motif within the medical report 100, and/or distinctive imagery or visualization in which a logical framework can be built. In some embodiments, one or more archetypes within the associations can be inferred by one or more logical inference models.

In the example embodiment shown, archetype node A1 702 corresponds to the “x-ray” archetype, which is associated with token node T5 610 and sentence node S1 502. Each archetype can have characteristics that define it and link it to other nodes within the ephemeral knowledge graph, such as its affect, ontology characteristic(s), ontology type, structure, location within the body, the system of the body it belongs to, the medical service that covers it, etc. For example, archetype node A1 702 “x-ray” is defined by characteristics: affect: human body; hierarchically catalogued: true; name: x-ray; ontology: Radiological Service; ontology type: concrete; static: true; taxonomy: null; and type of: plain radiography. Additionally and/or alternatively, archetype node A1 702 “x-ray” can be associated with sentence node S1 502 based on the following characteristics: ontology: Radiological Service; phrase number: 1; position: 1, source token node: token node T5 610, token position: 1; type: sentence.

Furthermore, archetype node A2 704 corresponds to the “knee” archetype, which is associated with token node T4 608 and sentence node S1 502. Archetype node A2 704 is defined by characteristics: hierarchically cataloged: true; name: knee; ontology: Anatomy; ontology type: concrete; static: true; type of: lower joint, major joint; part of: lower leg; structure: joint; structure category: member; system: musculoskeletal system; and taxonomical region: lower extremity. Additionally and/or alternatively, archetype node A1 704 “knee” can be associated with sentence node S1 502 based on position: 2.

Archetype node A3 706 corresponds to the “right” archetype, which is associated with token node T3 606 and sentence node S1 502. Archetype node A3 706 is defined by characteristics: hierarchically cataloged: true; name: right; ontology: Spatial; ontology type: concrete; and static: true.

Archetype node A4 708 corresponds to the “anteroposterior” archetype, which is associated with token node T2 604 and sentence node S1 502. Archetype node A4 708 is defined by characteristics: hierarchically cataloged: true; name: anteroposterior; ontology: Views; ontology type: concrete; and static: true.

Other archetype nodes may have more or less characteristics to define it, and/or may be attached to a sentence node rather than a token node. For example, archetype node A5 710 corresponds to the “lateral” archetype, which is associated with token node T1 602 and sentence node S1 502. In contrast, archetype node A0 700 is associated only with sentence node S1 502. Both archetype node A5 710 and archetype node A0 700 can be defined by the characteristics: hierarchically cataloged: true; name: lateral; ontology: Views; ontology type: concrete; and static: true.

Additionally and/or alternatively, archetypes can be unitary or compound depending on the token it is applied to. For example, a unitary token archetype association can be applied to portions of the unstructured data for unitary tokens, and a compound archetype association can be applied to the portions of the unstructured data for compound tokens. Compound tokens can be recognized from tokens unitary tokens by cross-referencing the corresponding ontological static data in memory (e.g., a preexisting graph engine).

Archetypes can the creation of the archetype nodes can span any characteristic that provides categorization, meaning, or insight into the analyzed text. For example, the ARNI system 400 can associate body parts with human anatomical regions by cross-referencing the ontological static data within a graph engine. These human anatomical regions can be attached to the appropriate portion(s) of each sentence. The ARNI system 400 can recognize token operators and attach operator archetypes to the appropriate portion(s) of each sentence. Token functions can be recognized, and function archetypes can be attached to the appropriate portion(s) of each sentence. The ARNI system 400 can recognize token punctuations and attach punctuation archetypes to the appropriate portion(s) of each sentence.

In some embodiments, the ARNI system 400 can use substring analysis to recognize when a token ends with a plural suffix and is a recognized entity without the suffix. The ARNI system 400 can then use the part of speech to narrow the likelihood of misunderstanding plural suffixes. The substring analysis and part of speech cues from ontological static data from the graph engine can then be used to solve plural noun variations within the text. Substring analysis can moreover be used to recognize unidentified tokens by their Greek or Latin roots to auto-categorize their ontology. This allows for each token to be assigned to its appropriate archetype node(s).

Other archetypes can be associated with one or more tokens based on substring analysis identifying adjectives, unilateral or bilateral archetypal characteristics, gendered terms, regulatory terms and ontologies, anatomy, rationale, contrast, service type (e.g., Radiological Service, IR Service, etc.), ephemeral date/time archetypes, ephemeral numerical value archetypes, etc.

FIG. 8 illustrates connecting archetypes through microgrammatical analysis within the ARNI system 400 in accordance with an example embodiment. One or more of archetype associations can be connected together based on a microgrammatical analysis of the text, where in some embodiments the microgrammatical analysis of the text is based on a phrase, sentence proximity, etc. This builds an ephemeral knowledge graph of the unstructured data based on the connection of the various archetype associations.

In the example embodiment shown, the “x-ray” archetype A1 702 is connected to the “knee” archetype A2 704 because archetype A1 702 “analyzes” 802a and “precedes” 802b archetype A2 704. The “knee” archetype A2 704 is connected to the “right” archetype A3 706 because archetype A2 704 “describes” 802c and “precedes” 802d archetype A3 706. The “right” archetype A3 706 is connected to the “anteroposterior” archetype A4 708 because archetype A3 706 “precedes” 802e archetype A4 708.

Archetypes may also be connected to more than one other archetype based on the microgrammatical analysis. For example, the “anteroposterior” archetype A4 708 is connected to the “knee” archetype A2 704 and the “lateral” archetypes A5 710 because archetype A4 708 “targets” 802f archetype A2 707, while archetype A4 708 “precedes” 802g archetype A5 710.

In some embodiments, microgrammatical analysis of the text can analyze and set archetype positions. For example, the ARNI system 400 can solve the difference between unitary and compound token positions and assign common denominator(s) to the archetype position(s). The ARNI system 400 can create links between archetypes that store the relative position of an archetype to another archetype. Function and operator connections can be reduced where the source token is NULL. In some embodiments, the ARNI system 400 can perform phrase recognition and/or identify sentence inflectors (e.g., alethic mood, deontic mood, temporal mood, ambiguous mood, affirmations and negations (polarities)), etc. Inflectors can be associated to archetypes by creating inflection relationships between inflectors and archetypes through micro grammatical analysis. For example, impossible inflections can be removed, the ARNI system 400 can determine if inflectors inflect upon the subject/object of the sentence or whether the inflectors inflect forward or backward through the sentence in active or passive voice. This information allows the ARNI system 400 to connect the various archetypes within the ephemeral knowledge graph.

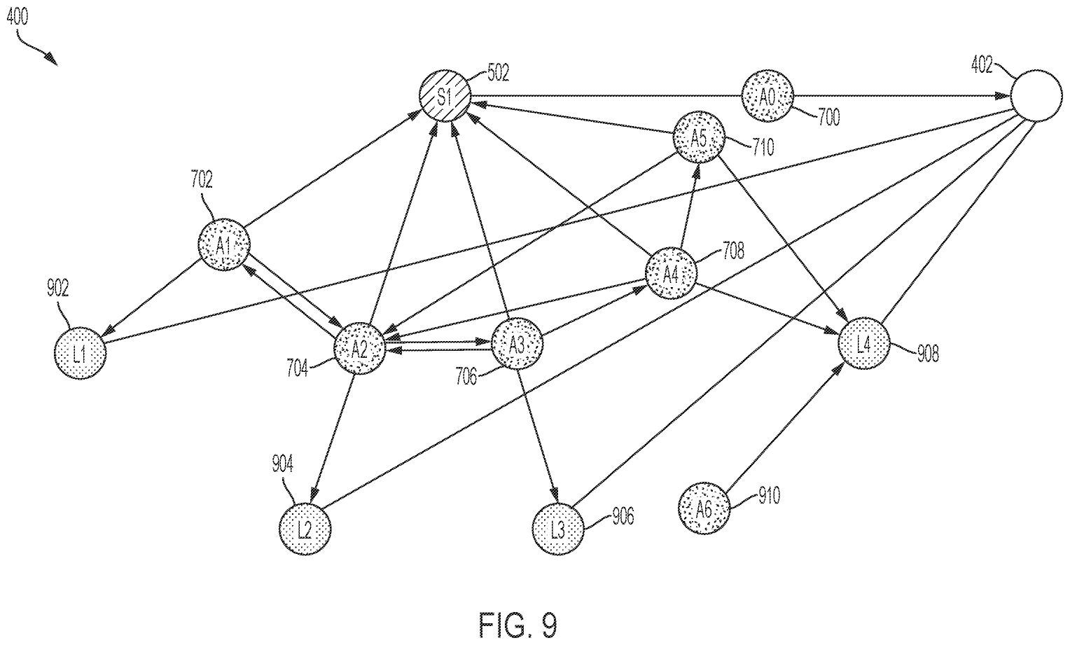

Once the microgrammatical analysis provides connections between the various archetypes defining the text within the medical report 100, FIG. 9 illustrates creating logics nodes within the ARNI system 400 in accordance with an example embodiment. For example, the ARNI system 400 can create one or more ontological logic nodes based on the unstructured data (e.g., text of the medical report 100). These ontological logic nodes build an ephemeral logics graph, where logical inference model(s) are applied to solve syllogisms applied to the text by setting inclusion or exclusion properties on archetypal relationships to the ontological logic nodes. Syllogisms are a form of logical argument that applies deductive reasoning to arrive at a conclusion based on two or more propositions that are asserted or assumed to be true. For example, syllogisms arise when a number of true premises (propositions or statements) validly imply a conclusion, or the main point that the argument aims to get across.

For example, as is shown in the example embodiment analyzing the medical report 100 in FIG. 1, FIG. 9 shows logic node L1 902, logic node L2 904, logic node L3 906, and logic node L4 908. Any requirements or conditions related to the logic node are verified by the ARNI system 400 by solving syllogisms related to the logic node (e.g., setting inclusion or exclusion properties on archetypal relationships). Logic node L1 902, for example, is associated with the ontology “Radiological Service”; logic node L2 904 is associated with the ontology “Anatomy”; logic node L3 906 is associated with the ontology “Spatial”; and logic node L4 908 is associated with the ontology “Views”. In some embodiments, logic nodes can be connected/associated with multiple archetypes, such as logic node L4 that is associated with archetype node A4 708, archetype node A5 710, and archetype node A6 910 (a “value” archetype—in this example: the value “2” fund in the text of the medical report 100).

The ontological logic nodes can be created with any type of characteristic or categorization that provides meaning to the unstructured text to be analyzed by ARNI. For example, ontological logic nodes can be based on, but not limited to: medical service, magnitude, medical device, spatial characteristics, medication, outcome, institution, gender, rationales, administration, administration types, administration forms, date/time, treatment, anatomy, dependency, physiology, age, contrast, causality, payer, either/or conditionals, non-causality, inclusion/exclusion of structure types, region/sub-region analysis, numbered/non-numbered anatomical references, general anatomical references, etc.

One or more types of logic can be employed within the logical inference model(s) that are applied to solve syllogisms based on the unstructured text. For example, the ARNI system 400 can include mathematical logic (e.g., node counting, standard counting, operator/function informed counting, variable range counting, alethic/deontic/temporal/ambiguous/polarity logic, modal logic, etc. In some embodiments, the logical inference model(s) can be a modal graph-based domain specific language model, which can combine induction heuristics with deductive techniques to deduce the content and meaning of language. These techniques can inform the creation of the ontological logic nodes, the logical inference model(s) applied, and/or the requirement logics operations. For example, the logical inference model(s) can implement modal logic (e.g., “it is necessary that” and “it is possible that”), deontic (moral) logic (e.g., “it is obligatory that” and “it is permitted that”), temporal logic (e.g., “it will always be the case that”, “it will be the case that”, “it has always been the case that”, “it was the case that”), doxastic logic (e.g., “xx believes that”, and/or epistemic logic (e.g., “xx knows that”), etc. The unstructured text or data can be analyzed based on the various logical expression types for their necessitation rules, distribution axioms, interaction axioms, etc. to determine symmetries/asymmetries between possible logical conclusions to be drawn from the text or data. The logical inference model(s) may use one or a combination of the logical expression types, such as by determining correspondence between axioms and conditions between different logic types (e.g., modal and temporal logics).

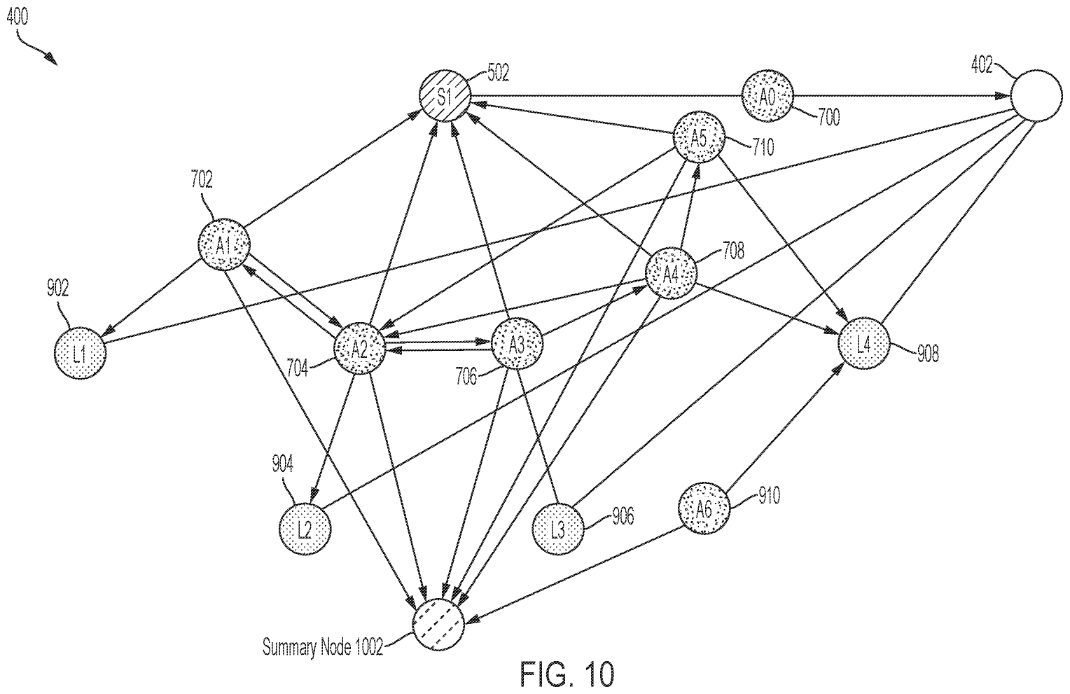

FIG. 10 illustrates the creation of a summary node based on the logics nodes within the ARNI system 400 in accordance with an example embodiment, although any number of summary nodes are contemplated based on the appropriate summarization of the ephemeral knowledge graph. In the example embodiment shown, summary node 1002 is created from the summarization of archetype node A1 702, archetype node A2 704, archetype node A3 706 archetype node A4 708, archetype node A5 710, and archetype node A6 910.

In some embodiments, the summarization process to create summary node 1002 can include using the ephemeral knowledge graph and the ephemeral logic graph to look for concepts that are repeated in the report, placed in positions of relative importance, etc. The ARNI system 400 can analyze the dimensions in which any particular aspect of the particular instance of a concept within the medical report 100 is more specific and isolate the instance, and/or the ARNI system 400 can synthesize a new statement of fact which is more specific in all (or a portion of) variable dimensions than any single instance of the concept within the medical report 100.

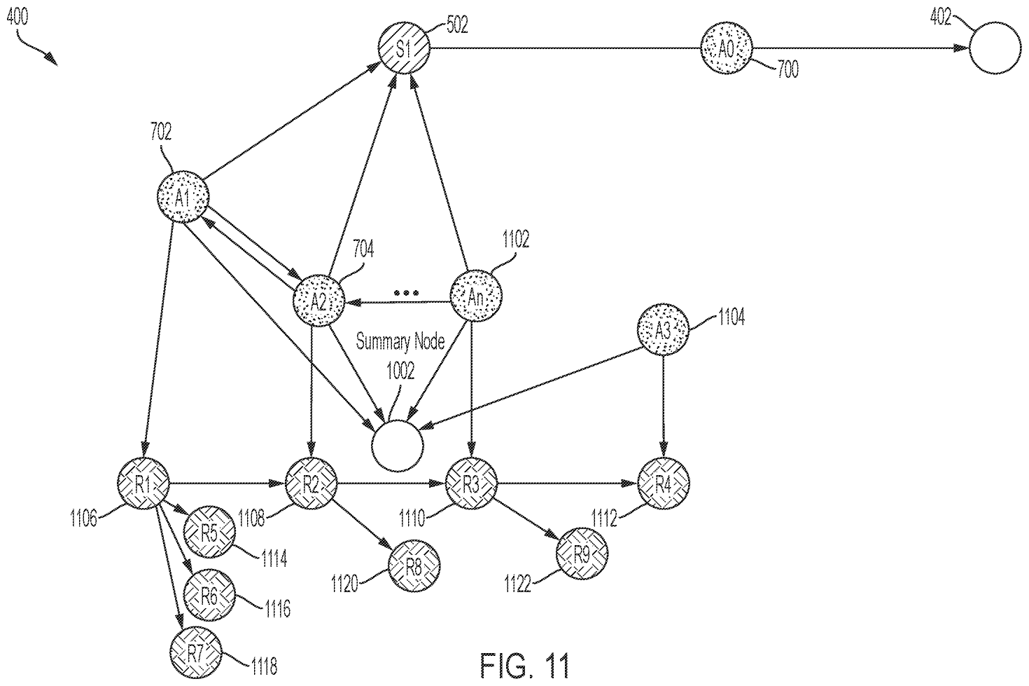

FIG. 11 illustrates a transverse Tree of Operational Requirement (TOOR) to determine requirement satisfaction within the ARNI system 400 in accordance with an example embodiment, although any tree or connected graph structure that can embed mathematical logic, functions, and/or relationships can be implemented.

In some embodiments, the ARNI system 400 can determine valid pathways through a static knowledge graph based on a comparison between nodes of an ephemeral knowledge graph and summary graphs of a report (e.g., medical report 100). Requirement logics operations can be performed on returned transversal pathways, and the ARNI system 400 can recursively run a check for an existence of a coded conclusion for the returned transversal pathways until a coded conclusion has been reached or no transversal pathway matches results of the logics operations.

For example, “x-ray” requirement node R1 1106 is created from archetype node A1 702. The ARNI system 400 can collect all CPT codes, modifiers, ICD-10 codes, MIPS codes, etc. And connect them to the medical report 100. For each recursively run check, the ARNI system 400 can validate that all predicates, operators, functions, etc. requirements are run on the returned transversal pathways. For each path, the ARNI system 400 can check to see if some coded conclusion based on R1 1106 exists as a leaf node in the TOOR system. When either a coded conclusion has been reached or no transversal pathway matches the results of the logical operation, the recursive loop ends on a per branch basis. For example, the branch of requirement node R1 1106 includes “tibia” requirement node R5 1114, “ankle” requirement node R6 1116, and “foot” requirement node R7 1118.

Similarly, “knee” requirement node R2 11108 is created from archetype node A2 704, with a branch including “left” requirement node R8 1120. “Right” requirement node R3 1110 is created from archetype node An 1102, with a branch including “left” requirement node R9 1122; and “logic” requirement node R4 1112 is created from archetype node A3 1104.

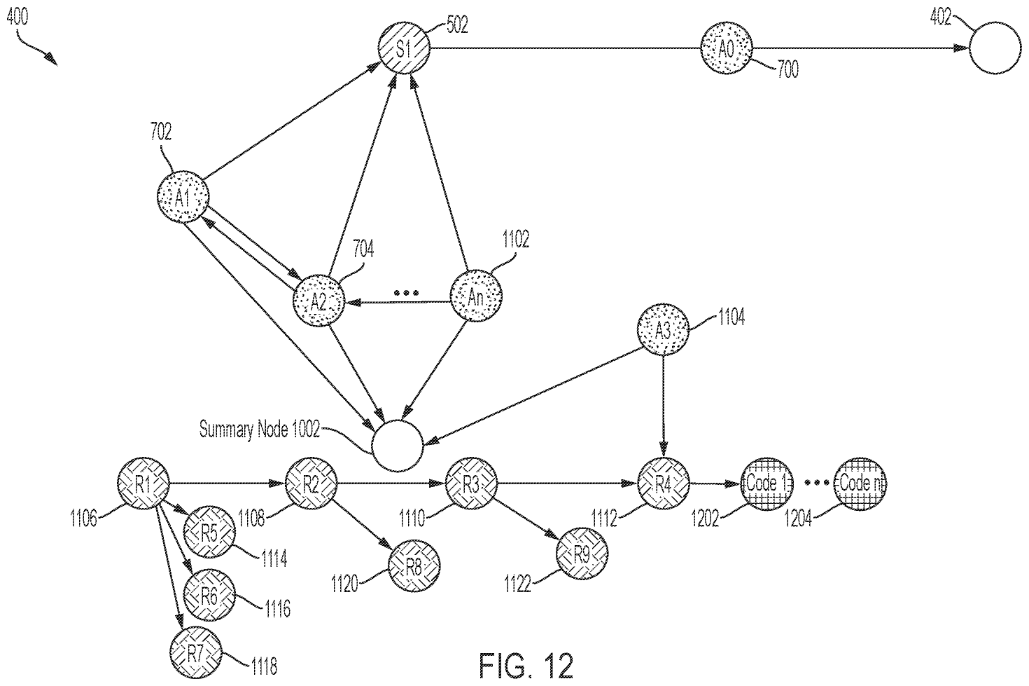

FIG. 12 illustrates code selection within the ARNI system 400 after all the requirement nodes have been created and analyzed, in accordance with an example embodiment. The ARNI system 400 assigns a code (e.g., code 1 1202 . . . code n 1204) to a portion of the text if a coded conclusion has been reached. In some embodiments, one or more codes may apply to overlapping portions of text. The codes can correspond to any type of system of words, letters, figures, or other symbols that provide meaning or summarization to portions of the unstructured text, such as CPT codes, modifiers, ICD-10 codes, MIPS codes, etc. In some embodiments, these code 1 1202 . . . code n 1204 can be encapsulated in a subgraph within the static knowledge graph, and any child codes can be determined and applied if appropriate.

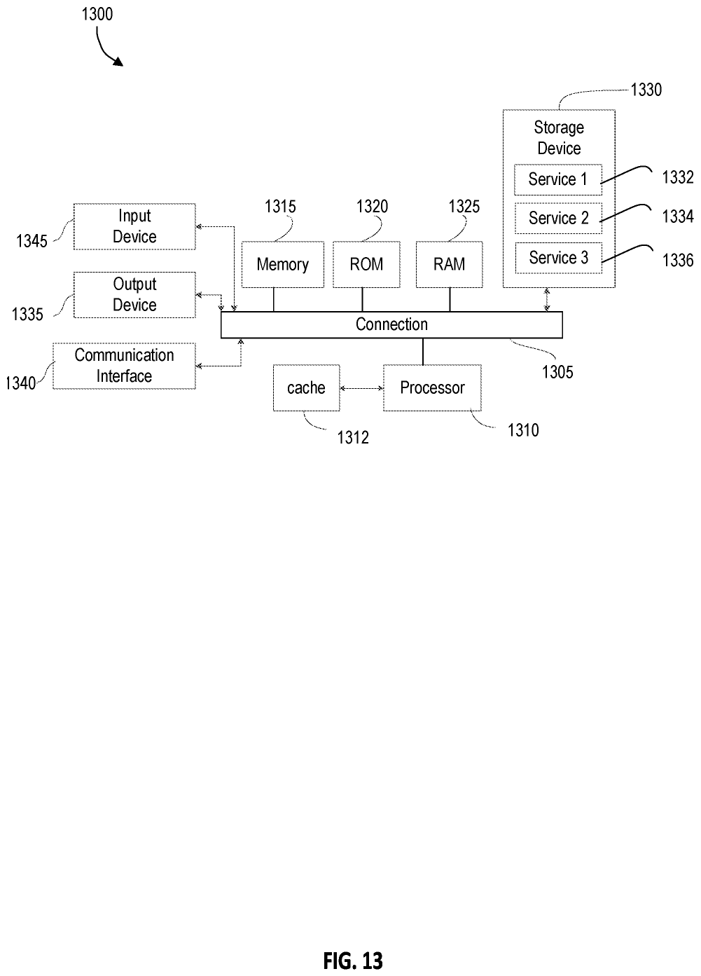

FIG. 13 shows an example of computing system 1300, which can be for example any computing device or any component thereof in which the components of the system shown in FIGS. 2 and 4-12 are in communication with each other using connection 1305. Connection 1305 can be a physical connection via a bus, or a direct connection into processor 1310, such as in a chipset architecture. Connection 1305 can also be a virtual connection, networked connection, or logical connection.

In some embodiments computing system 1300 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 1300 includes at least one processing unit (CPU or processor) 1310 and connection 1305 that couples various system components including system memory 1315, such as read only memory (ROM) 1320 and random access memory (RAM) 1325 to processor 1310. Computing system 1300 can include a cache of high-speed memory 1312 connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms known to those of skill in the art. In some instances, multimodal systems can enable a user to provide multiple types of input/output to communicate with computing system 1300. Computing system 1300 can include communications interface 1340, which can generally govern and manage the user input and system output. There is no restriction on operating on any particular hardware arrangement and therefore the basic features here may easily be substituted for improved hardware or firmware arrangements as they are developed.

Storage device 1330 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 1330 can include software services, servers, services, etc., that when the code that defines such software is executed by the processor 1310, it causes the system to perform a function. In some embodiments, a hardware service that performs a particular function can include the software component stored in a computer-readable medium in connection with the necessary hardware components, such as processor 1310, connection 1305, output device 1335, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for a holistic logical inference model comprising:
receiving unstructured data, wherein the unstructured data includes text; and
applying a logical inference model to at least one or more portions of the unstructured data that applies an induction heuristic model to generate a meaning to the at least one or more portions of the unstructured data.

2. The method of claim 1, the method further comprising:
applying contextual analysis and phrase recognition to the at least one or more portions of the unstructured data; and
based on the contextual analysis and the phrase recognition, applying the logical inference model that combines the induction heuristic model with at least one deductive technique to generate the meaning to the at least one or more portions of the unstructured data, wherein the logical inference model mimics human logical reasoning applied to the unstructured data.

3. The method of claim 1, the method further comprising:
assigning a portion of the text within the unstructured data to a labelled section and attaching the labelled section to a report node within a knowledge graph;
breaking the portion of the text into one or more sentences and attaching the one or more sentences to a section node within the knowledge graph; and
breaking the one or more sentences into one or more tokens and attaching the one or more tokens to a sentence node within the knowledge graph;
wherein the report node, the section node, and the sentence node preserves ordered position within the knowledge graph.

4. The method of claim 1, the method further comprising:
determining one or more tokens from the text of the unstructured data;
recognizing compound tokens from among unitary tokens within the one or more tokens by cross referencing ontological static data in memory;
applying a unitary token archetype association to portions of the unstructured data for unitary tokens; and
applying a compound archetype association to the portions of the unstructured data for compound tokens.

5. The method of claim 1, the method further comprising:
connecting a plurality of archetype associations together based on a microgrammatical analysis of the text, wherein the microgrammatical analysis of the text is based on one or more of a phrase or sentence proximity; and
building an ephemeral knowledge graph of the unstructured data based on the connection of the plurality of archetype associations.

6. The method of claim 5, wherein one or more archetypes within the plurality of archetype associations are inferred by the logical inference model.

7. The method of claim 1, the method further comprising:
creating ontological logic nodes based on the unstructured data;
building an ephemeral logics graph based on the ontological logic nodes; and
applying the logical inference model to solve syllogisms applied to the text by setting inclusion or exclusion properties on archetypal relationships to the ontological logic nodes.

8. The method of claim 1, the method further comprising:
determining valid pathways through a static knowledge graph based on a comparison between nodes of an ephemeral knowledge graph and summary graphs of a report;
performing requirement logics operations on returned transversal pathways; and
recursively run a check for an existence of a coded conclusion for the returned transversal pathways until a coded conclusion has been reached or no transversal pathway matches results of the logics operations; and
assign a code to a portion of the text if the coded conclusion has been reached.

9. A computing apparatus comprising:
a processor; and
a memory storing instructions that, when executed by the processor, configure the apparatus to:
receive unstructured data, wherein the unstructured data includes text; and
apply a logical inference model to at least one or more portions of the unstructured data that applies an induction heuristic model to generate a meaning to the at least one or more portions of the unstructured data.

10. The computing apparatus of claim 1, wherein the instructions further configure the apparatus to:
apply contextual analysis and phrase recognition to the at least one or more portions of the unstructured data; and
based on the contextual analysis and the phrase recognition, apply the logical inference model that combines the induction heuristic model with at least one deductive technique to generate the meaning to the at least one or more portions of the unstructured data, wherein the logical inference model mimics human logical reasoning applied to the unstructured data.

11. The computing apparatus of claim 1, wherein the instructions further configure the apparatus to:
assign a portion of the text within the unstructured data to a labelled section and attaching the labelled section to a report node within a knowledge graph;
break the portion of the text into one or more sentences and attaching the one or more sentences to a section node within the knowledge graph; and
break the one or more sentences into one or more tokens and attaching the one or more tokens to a sentence node within the knowledge graph;
wherein the report node, the section node, and the sentence node preserves ordered position within the knowledge graph.

12. The computing apparatus of claim 1, wherein the instructions further configure the apparatus to:
determine one or more tokens from the text of the unstructured data;
recognize compound tokens from among unitary tokens within the one or more tokens by cross referencing ontological static data in memory;
apply a unitary token archetype association to portions of the unstructured data for unitary tokens; and
apply a compound archetype association to the portions of the unstructured data for compound tokens.

13. The computing apparatus of claim 1, wherein the instructions further configure the apparatus to:
connect a plurality of archetype associations together based on a microgrammatical analysis of the text, wherein the microgrammatical analysis of the text is based on one or more of a phrase or sentence proximity; and
build an ephemeral knowledge graph of the unstructured data based on the connection of the plurality of archetype associations.

14. The computing apparatus of claim 5, wherein one or more of archetypes within the plurality of archetype associations is inferred by the logical inference model.

15. The computing apparatus of claim 1, wherein the instructions further configure the apparatus to:
create ontological logic nodes based on the unstructured data;
build an ephemeral logics graph based on the ontological logic nodes; and
apply the logical inference model to solve syllogisms applied to the text by setting inclusion or exclusion properties on archetypal relationships to the ontological logic nodes.

16. The computing apparatus of claim 1, wherein the instructions further configure the apparatus to:
determine valid pathways through a static knowledge graph based on a comparison between nodes of an ephemeral knowledge graph and summary graphs of a report;
perform requirement logics operations on returned transversal pathways; and
recursively run a check for an existence of a coded conclusion for the returned transversal pathways until a coded conclusion has been reached or no transversal pathway matches results of the logics operations; and
assign a code to a portion of the text if the coded conclusion has been reached.

17. A non-transitory computer-readable storage medium, the computer-readable storage medium including instructions that when executed by a computer, cause the computer to:
receive unstructured data, wherein the unstructured data includes text; and
apply a logical inference model to at least one or more portions of the unstructured data that applies an induction heuristic model to generate a meaning to the at least one or more portions of the unstructured data.

18. The non-transitory computer-readable storage medium of claim 1, wherein the instructions further configure the computer to:
apply contextual analysis and phrase recognition to the at least one or more portions of the unstructured data; and
based on the contextual analysis and the phrase recognition, apply the logical inference model that combines the induction heuristic model with at least one deductive technique to generate the meaning to the at least one or more portions of the unstructured data, wherein the logical inference model mimics human logical reasoning applied to the unstructured data.

19. The non-transitory computer-readable storage medium of claim 1, wherein the instructions further configure the computer to:
assign a portion of the text within the unstructured data to a labelled section and attaching the labelled section to a report node within a knowledge graph;
break the portion of the text into one or more sentences and attaching the one or more sentences to a section node within the knowledge graph; and
break the one or more sentences into one or more tokens and attaching the one or more tokens to a sentence node within the knowledge graph;
wherein the report node, the section node, and the sentence node preserves ordered position within the knowledge graph.

20. The non-transitory computer-readable storage medium of claim 1, wherein the instructions further configure the computer to:
determine one or more tokens from the text of the unstructured data;
recognize compound tokens from among unitary tokens within the one or more tokens by cross referencing ontological static data in memory;
apply a unitary token archetype association to portions of the unstructured data for unitary tokens; and
apply a compound archetype association to the portions of the unstructured data for compound tokens.
